(19) United States
(12) Patent Application Publication
(10) Pub. No.: US 2008/0307199 A1
(43) Pub. Date: Dec. 11, 2008

(54) Portable extended display identification data burning device

(75) Inventors: Shih-Hua Tseng, Taipei (TW); Jhih-Jen Wu, Taipei (TW)

Correspondence Address: BACON & THOMAS, PLLC, 625 SLATERS LANE, FOURTH FLOOR, ALEXANDRIA, VA, 22314-1176, US

(73) Assignee: Tatung Company, Taipei (TW)

(21) Appl. No.: 12/003,533

(22) Filed: Dec. 28, 2007

(30) Foreign Application Priority Data
Jun. 8, 2007 (TW) 096120880

(51) Int. Cl. G06F 15/00

(52) U.S. Cl. 712/37; 712/E09.001

(57) ABSTRACT

The present invention relates to a portable extended display identification data (EDID) burning device, which could perform an EDID burning operation via an input device without connecting to a computer. The portable EDID burning device comprises: at least one video connection interface connected to a to-be-burned display device, a memory unit used for storing EDID and system data, an input device interface used for connecting to the input device, and a microcontroller electronically connected to the at least one video connection interface, the memory unit and the input device interface. Therefore, the present invention could be departed from a computer structure and could directly burn in the EDID. That is, the present invention could burn in more than one connection interface at a time during an independent operation, thereby saving cost and time.

### BACKGROUND OF THE INVENTION

1. Field of the Invention

The present invention relates to a device for burning in extended display identification data, and more particularly, to an extended display identification data burning device which burns in extended display identification data without using a computer.

2. Description of Related Art

With the popularity of computer technology, the plug and play function becomes an essential function of computer peripheral equipment. As to a display device, the video electronics standard association (VESA) is responsible for promoting and developing important display device and display interface standards, so as to make sure its commonality. Extended display identification data (EDID) standard is one of the standard data formats been established by VESA. EDID includes basic data of a display device, such as: manufacturer information, maximum image size, color feature, usage frequency limitation, and etc. The EDID is stored in a display device and used for communicating with a host, thereby achieving the plug and play function.

In a conventional technique, the manufacturer uses a personal computer (PC) structure as its operation way. That is, writing EDID into a non-erasable memory via a VGA interface or DVI interface of the display device.

FIG. 1A and FIG. 1B illustrate schematic drawings of conventional EDID burning operations and devices. As shown in both FIG. 1A and FIG. 1B, a computer device 193 is connected to a display device 191 by means of a transmission line 194, and performs an EDID burning operation to the display device 191 via a scanner 192. The only difference between FIG. 1A and FIG. 1B is that, in FIG. 1A, the computer device 193 has to use a graphics card with a VGA interface to perform the burning operation to a VGA interface 1911 of the display device 191. However, under such connected burning way, the graphics card of the computer device 193 must have a VESA BIOS extensions (VBE) function, otherwise there would always result in a compatibility-not-supported situation.

Further, the difference in FIG. 1B is that an interface converting device 195 is added for not only overcoming the above VBE compatibility problem, but also performing the burning operation to a DVI interface 1912 of the displays, such that the VGA interface of the computer could be adapted to different interfaces of the display device 191 through conversion.

With regard to another conventional burning operation and device as shown in FIG. 2, a computer device 293 comprises a printer port 2931 or other port such as RS232, USB, and so on. In the conventional burning way, the printer port 2931 or other port is connected to a DVI interface 2911 of a display device 291 via an interface converting device 295, so as to write EDID into the display device 291. Moreover, an interface converting device 295 must be added to a transmission line 294 between the aforementioned printer port 2931 and the DVI interface 2911 in advance, and then a printer 292 could be used to perform the burning operation to the display device 291.

However, there are a lot of shortcomings in the above-mentioned conventional EDID burning operation ways, such as: (1) only burning one video connection interface at a time; (2) a PC and an additional video signal resource are required during the burning operation; (3) a PC graphics card has to be a specific graphics card which supports the VBE function, otherwise a printer port or other port with an additional interface converting device is required; (4) the burning operation could only be performed at a fixed location; (5) a monitor is required for observing the operation result, however, the operator would probably encounter a determination inconvenience situation due to his/her angle of view.

Therefore, it is desirable to provide a portable extended display identification data burning device to mitigate and/or obviate the aforementioned problems.

### SUMMARY OF THE INVENTION

In order to solve the abovementioned problems, the present invention provides a portable extended display identification data (EDID) burning device, which performs an EDID burning operation via an input device without connecting to an external computer, the portable EDID burning device comprising: at least one video connection interface, connected to a to-be-burned display device; a memory unit, used for storing EDID and system data; an input device interface, used for connecting to the input device; and a microcontroller, electronically connected to the at least one vide connection interface, the memory unit, and the input device interface.

According to the above description, the input device inputs a product barcode on the to-be-burned display device to obtain product data, then the microcontroller combines the product data with the EDID retrieved from the memory unit for being burned into the to-be-burned display device via the at least one video connection interface. Therefore, the present invention provides a portable EDID burning device, which is departed from a computer structure and could directly burn in the EDID without adding a video signal source, and could burn in more than one connection interface at a time during an independent operation without being mounted at a fixed location. Accordingly, the present invention saves cost and time, solves the problem that a PC graphics card must be a specific graphics card which supports the VBE function, and also solves the problem that the operator encounters a determination inconvenience situation due to his/her angle of view.

According to the above description, the input device of the portable EDID burning device of the present invention could be a keyboard device, a barcode input device, or a radio frequency identification (RFID), and etc. The input device is not limited in either a wired input device or a wireless input device. Further, the barcode input device could be a barcode scanner.

According to the above description, the portable EDID burning device of the present invention further comprises an expansion interface, electronically connected to the microcontroller, used for downloading high-bandwidth digital content protection (HDCP) data by collaborating with a multiplexer to connect to the burning device. Preferably, eight or even more batches of data could be burned in at a time.

According to the above description, the portable EDID burning device of the present invention further comprises a display unit, connected to the expansion interface, used for displaying the product data after the input device inputs the product barcode on the to-be-burned display device to obtain the product data. Further, the display unit could also display burning status information after completing the burning operation; therefore, from the display unit, a user could obtain the information of a product type, a product serial number, a manufacturing data, and/or whether the data burning operation is successful.

According to the above description, the portable EDID burning device of the present invention further comprises a speaker, electronically connected to the microcontroller, used for informing a burning status message, such that the operator could obtain the burning status message by directly hearing the sound generated from the speaker.

According to the above description, the portable EDID burning device of the present invention further comprises an indicator light set, electronically connected to the microcontroller, used for informing the burning status message. Preferably, the indicator light set comprises a green LED, a red LED and a yellow LED, such that the operator could also obtain the burning status message via the indicator light set under a noisy working environment.

According to the above description, the portable EDID burning device of the present invention further comprises an external computer connection interface, electronically connected to the microcontroller, used for connecting to an external computer, so as to download data for updating the EDID of the memory unit, or upload counting value data included in the system data of the memory, wherein the counter data includes a counting value provided to the microcontroller as a counter data update. The external computer connection interface is preferably RS-232, or other equivalent connection interfaces.

According to the above description, the portable EDID burning device of the present invention further comprises a power unit, which performs a discharging process to supply power to each unit. The power unit could perform a charging process by using an input device with a power input unit to supply direct current. The power input unit preferably uses 9˜12 direct current voltage, for example, a general DC-9˜12 power transformer. Further, under a power supply status, the power input unit could also obtain necessary power from the portable EDID burning device.

### BRIEF DESCRIPTION OF THE DRAWINGS

FIGS. 1A˜1B illustrate schematic drawings of conventional EDID burning operations and devices.

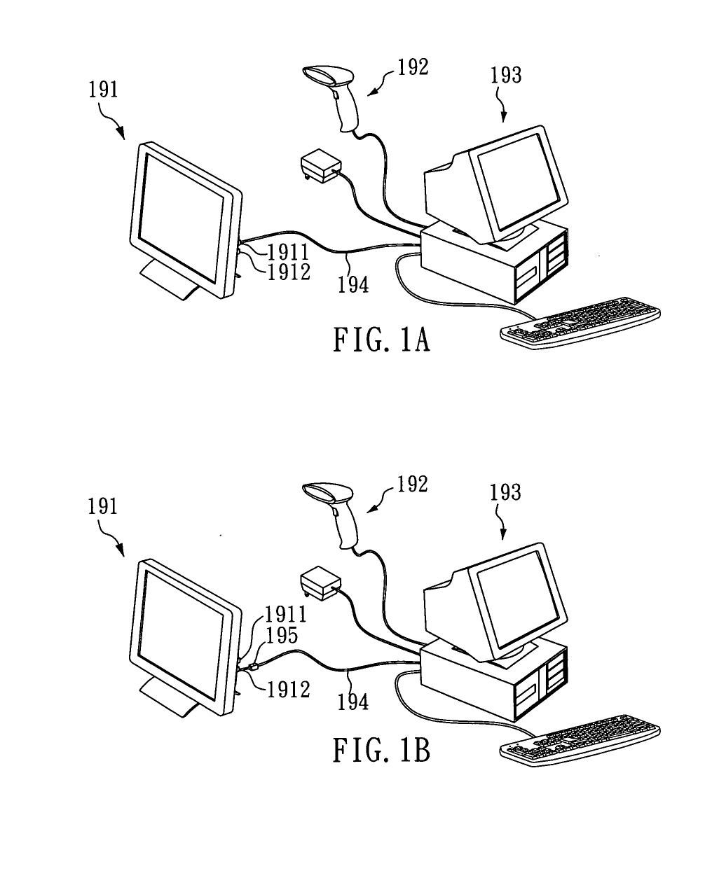

FIG. 2 illustrates a schematic drawing of another conventional EDID burning operation and device.

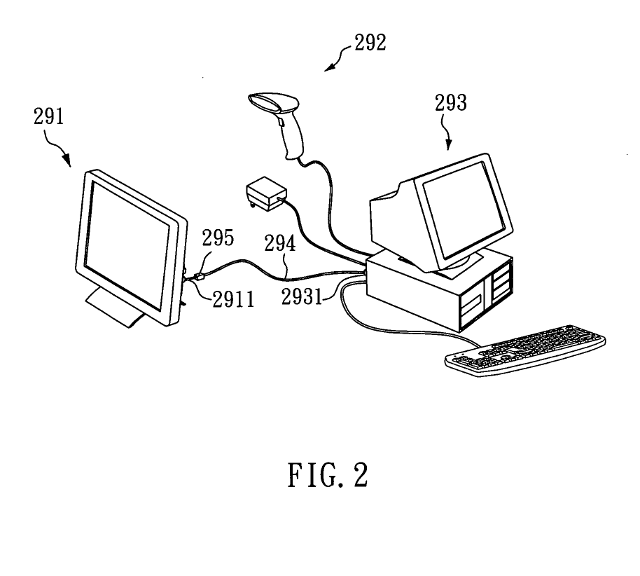

FIG. 3 illustrates a schematic drawing of an EDID burning operation device of one preferred embodiment according to the present invention.

FIG. 4 illustrates a schematic drawing of a product barcode of one preferred embodiment according to the present invention.

### DETAILED DESCRIPTION OF THE PREFERRED EMBODIMENT

Below please find specific embodiments to explain the implementation of the present invention, such that a person skilled in the art could easily understand the advantage and effect of the present invention according to the disclosure of this specification.

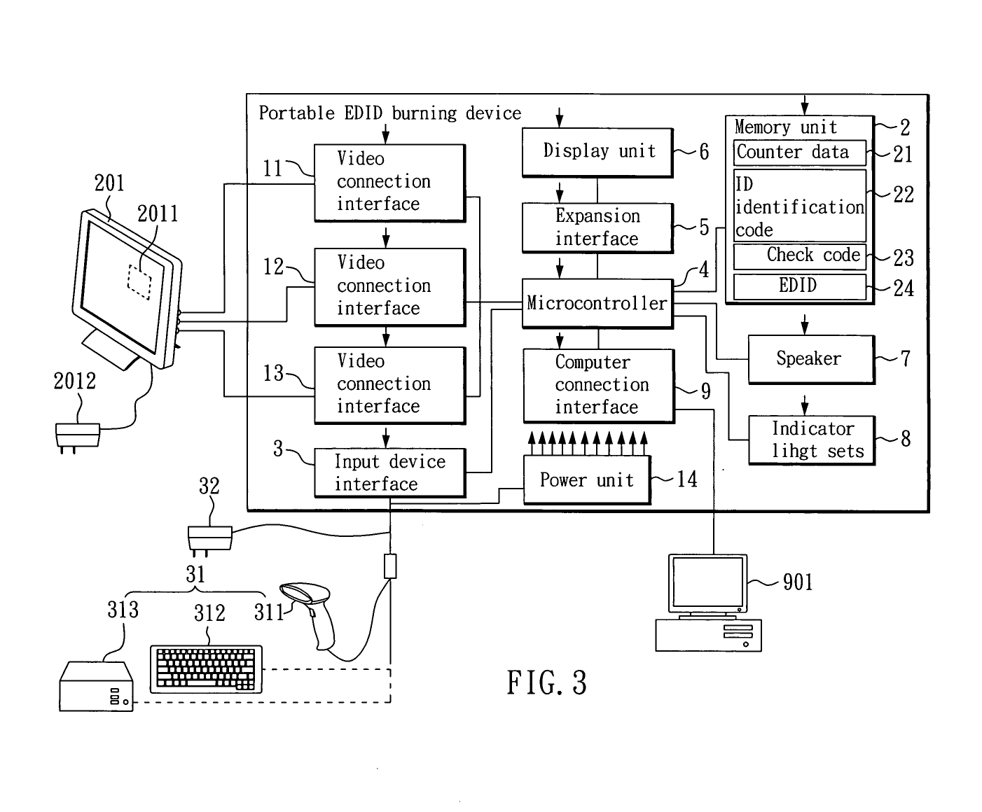

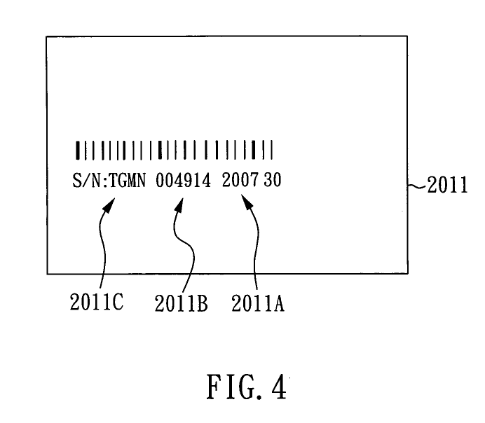

FIGS. 3˜4 disclose a first embodiment of the present invention. As shown in FIG. 3, the portable EDID burning device 100 of the present invention is connected to an input device 31 via an input device interface 3, so as to perform a burning operation to the to-be-burned display device 201. The to-be-burned display device 201 must have an independent product barcode 2011 including a manufacturing date 2011A, a product serial number 2011B and a product type 2011C as preferably shown in FIG. 4. Only after the input device 31 scans it, the burning operation would start. In the first embodiment, the portable EDID burning device 100 could perform the burning operation to a display device of any brand via the input device 31 only when the product barcode is transformed to an analytic format of the portable EDID burning device 100 of the present invention. Further, the present invention selectively provides a power unit 14 to supply power to each unit as shown in the arrowheads of FIG. 3, or sets a power input unit 32 in the input device 31 for supplying direct current to the portable EDID burning device 100. In this embodiment, the power input unit 32 is a transformer, which supplies 9˜12 direct current voltage after connecting to general alternating current. The power input unit 32 could also supply power to the to-be-burned display device 201, such that EDID 24 could still be transmitted to the to-be-burned display device 201 without plugging in or turning on the to-be-burned display device 201.

The portable EDID burning device 100 of the present invention mainly comprises three video connection interfaces 11, 12 and 13, a memory unit 2, an input device interface 3, a microcontroller 4, an expansion interface 5, a display unit 6, a speaker 7, an indicator light set 8, and an external computer connection interface 9. Each of the above unit would be described in details as follows.

The video connection interfaces 11, 12 and 13 are connected to corresponding video interfaces of the display device 201 through general transmission lines. In this embodiment, the video connection interfaces 11, 12 and 13 are preferably selected from any three of the following: a VGA video connection interface, a DVI video connection interface, a HDMI video connection interface, a Display Port video connection interface and a UDI video connection interface.

The memory unit 2 stores EDID 24 and system data, wherein the system data could further include counter data 21, ID identification code 22, check code 23, system parameters, type data, and etc. The counter data 21 includes a counting value which could be used as statistics data. The ID identification code 22 is the only one identification code for the portable EDID burning device, used for obtaining an authorization of downloading the EDID 24 by means of registration. The check code 23 is used as Oversight-Prevent function to prevent a machine type from being incorrectly burned in. In the first embodiment, the memory unit 2 is preferably an electrically erasable programmable read-only memory (EEPROM), or a flash ROM.

The input device interface 3 is used for connecting to the input device 31. In this embodiment, all settings and operations are executed by using the input device 31 to input the barcode. Further, the inputted barcode comprises a product type 2011C used as an Oversight-Prevent code for being compared with the check code 23 of the memory unit 2. Such Oversight-Prevent mechanism is used to prevent a machine type from being incorrectly burned in.

The expansion interface 5 is electronically connected to the microcontroller 4, and could download high-bandwidth digital content protection (HDCP) data to the portable EDID burning device by collaborating with a multiplexer. Further, eight or even more batches of data could be burned in at a time.

The display unit 6 is connected to the expansion interface 5, used for displaying the product data after the input device 31 inputs the product barcode 2011 on the to-be-burned display device 201 to obtain the product data, such as a product type, a product serial number and a manufacturing date. Further, the display unit 6 could also used for displaying burning status information after completing the burning operation. For example, displaying the information about whether or not the burning operation is successful.

The speaker 7 is electronically connected to the microcontroller 4, used for informing a burning status message.

The indicator light set 8 is electronically connected to the microcontroller 4, used for informing a burning status message as well. In this embodiment, the indicator light set 8 comprises a green LED, a red LED and a yellow LED. For example, if the burning operation is successful, a green light would be emitted through the green LED; otherwise, a red light would be emitted through the red LED; while the yellow LED is used to indicate the power strength.

The external computer connection interface 9 is electronically connected to the microcontroller 4, used for connecting to an external computer 901 to download data for updating the EDID 24 of the memory unit 2. Please note that after completing the update of the EDID 24, the burning operation could be performed without connecting to any computer device. In this embodiment, the external computer connection interface 9 is RS-232. When using RS-232 to update the EDID 24 of the EEPROM, the user has to register to a system database in advance. Therefore, the system database would be stored with the only ID identification code of the registered user, and then the EDID 24 of the EEPROM could be updated only after obtaining an authorization of downloading the EDID. Further, after connecting to the external computer 901, the external computer connection interface 9 could download the counter data 21 of the memory unit 2 as statistics data, in order to charge the user accordingly.

This embodiment discloses a portable EDID burning device 100 which could perform the burning operation independently. Namely, this embodiment is departed from a personal computer and could directly burn in the EDID. It firstly completes all settings and operations of the portable EDID burning device 100 by using the input device 31 to input a control barcode. Next, when executing the burning function, the input device 31 inputs the product barcode 2011 on the to-be-burned display device 201 to obtain the product data. Then, the microcontroller 4 combines the product data with the EDID 24 retrieved from the memory unit 2. Meanwhile, the combined data would be stored to the to-be-burned display device 201 via three video connection interfaces 11, 12 and 13. Finally, the microcontroller 4 updates the counter data 21 of the memory unit 2. That is, when burning the EDID at a time, the value of the memory unit 2 would be immediately accumulated.

Therefore, the present invention provides a portable EDID burning device, which is departed from a computer structure and could directly burn in the EDID without adding a video signal source. That is, it could be departed from alternating current source, and could burn in more than one connection interface at a time during an independent operation without being mounted at a fixed location. Accordingly, the present invention saves cost and time, solves the problem that a PC graphics card must be a specific graphics card which supports the VBE function, and also solves the problem that the operator encounters a determination inconvenience situation due to his/her angle of view.

Please refer to FIG. 3 again, which further discloses a second embodiment of the present invention. As shown in FIG. 3, the components of the portable EDID burning device 100 of the second embodiment are mostly the same except for the power supply portion. In this embodiment, the portable EDID burning device 100 could use the power unit 14 to supply power to the to-be-burned display device 201 by connecting to a connection end of the to-be-burned display device 201 through three video connection interfaces 11, 12 and 13, thereby supplying power to the to-be-burned display device 201.

Accordingly, the power supply source of the present invention has a variety of designs. Therefore, whether or not the to-be-burned display device or a television with computer interface is plugged in the alternating current source 2012, the burning operation could be performed anyway.

Please refer to FIG. 3 again, which further discloses a third embodiment of the present invention. As shown in FIG. 3, the components of the portable EDID burning device 100 of the third embodiment are mostly the same except that the input device 31 could preferably be a barcode scanner 311, also could be a keyboard 312, or a radio frequency identification (RFID) device 313. Therefore, the present invention has a variety of input ways for the input device 31, such that either a wired input device or a wireless input device could perform a barcode input anyway.

Although the present invention has been explained in relation to its preferred embodiment, it is to be understood that many other possible modifications and variations can be made without departing from the spirit and scope of the invention as hereinafter claimed.

What is claimed is:

1. A portable extended display identification data (EDID) burning device, which performs an EDID burning operation via an input device without connecting to an external computer, the burning device comprising:
at least one video connection interface, connected to a to-be-burned display device;
a memory unit, used for storing EDID and system data;
an input device interface, used for connecting to the input device; and
a microcontroller, electronically connected to the at least one vide connection interface, the memory unit, and the input device interface;
wherein, the input device inputs a product barcode on the to-be-burned display device to obtain product data, then the microcontroller combines the product data with the EDID retrieved from the memory unit, and transmits to the to-be-burned display device.

2. The portable EDID burning device as claimed in claim 1, further comprising an expansion interface electronically connected to the microcontroller.

3. The portable EDID burning device as claimed in claim 2, wherein the expansion interface could download data by collaborating with a multiplexer.

4. The portable EDID burning device as claimed in claim 2, further comprising a display unit, connected to the expansion interface, used for displaying the product data after the input device inputs the product barcode on the to-be-burned display device to obtain the product data.

5. The portable EDID burning device as claimed in claim 4, wherein, the display unit could display burning status information after completing the burning operation.

6. The portable EDID burning device as claimed in claim 1, wherein the product information includes a product type, a product serial number and a manufacturing date.

7. The portable EDID burning device as claimed in claim 1, further comprising a speaker, electronically connected to the microcontroller, used for informing a burning status message.

8. The portable EDID burning device as claimed in claim 1, further comprising an indicator light sets, electronically connected to the microcontroller, used for informing a burning status message.

9. The portable EDID burning device as claimed in claim 8, wherein the indicator light sets comprises a green LED, a red LED and a yellow LED.

10. The portable EDID burning device as claimed in claim 1, wherein the memory unit is further used for storing counter data, which is provided to the microcontroller as a counter data update of the memory unit.

11. The portable EDID burning device as claimed in claim 10, wherein the counter data is included in the system data.

12. The portable EDID burning device as claimed in claim 10, further comprising an external computer connection interface, electronically connected to the microcontroller, used for connecting to an external computer, so as to download data for updating the EDID of the memory unit.

13. The portable EDID burning device as claimed in claim 12, wherein the external computer connection interface is used for connecting to the external computer, so as to upload the counter data of the memory unit.

14. The portable EDID burning device as claimed in claim 1, wherein the memory unit is further used for storing a check code as Oversight-Prevent function.

15. The portable EDID burning device as claimed in claim 1, wherein the memory unit is further used for storing an ID identification code, which is the only one identification code for the EDID burning device, used for obtaining an authorization of downloading the EDID by means of registration.

16. The portable EDID burning device as claimed in claim 1, further comprising a power unit with a charging/discharging function, used for supplying power to each unit.

17. The portable EDID burning device as claimed in claim 16, wherein the input device further comprises a power input unit, used for charging the power unit.

18. The portable EDID burning device as claimed in claim 1, wherein the input device further comprises a power input unit, used for supplying power to each unit.

19. The portable EDID burning device as claimed in claim 18, wherein the power input unit supplies direct current.

20. The portable EDID burning device as claimed in claim 18, wherein the power input unit could also supply power to the to-be-burned display device, therefore the EDID could still be transmitted to the to-be-burned display device without plugging in or turning on the to-be-burned display device.

21. The portable EDID burning device as claimed in claim 1, wherein the at least one video connection interface comprises a VGA video connection interface, a DVI video connection interface, a HDMI video connection interface, a Display Port video connection interface and a UDI video connection interface.

22. The portable EDID burning device as claimed in claim 1, wherein the memory unit is an electrically erasable programmable read-only memory (EEPROM).

23. The portable EDID burning device as claimed in claim 1, wherein the input device is a barcode scanner.

24. The portable EDID burning device as claimed in claim 1, wherein the input device is a keyboard.

25. The portable EDID burning device as claimed in claim 1, wherein the input device is a wireless input device.

26. The portable EDID burning device as claimed in claim 25, wherein the wireless input device is a radio frequency identification (RFID) device.

27. The portable EDID burning device as claimed in claim 25, wherein the wireless input device is a wireless keyboard.
